(19) United States
(12) Patent Application Publication
(10) Pub. No.: US 2025/0178690 A1
(43) Pub. Date: Jun. 5, 2025

(54) MODULE FOR A BICYCLE, KIT FOR A BICYCLE AND BICYCLE

(71) Applicant: Porsche eBike Performance GmbH, Ottobrunn (DE)

(72) Inventors: Stephan Happ, Ottobrunn (DE); Jannick Mohr, Ottobrunn (DE)

(21) Appl. No.: 18/842,684

(22) PCT Filed: Mar. 13, 2023
(86) PCT No.: PCT/EP2023/056284

§ 371 Date: Aug. 29, 2024

(30) Foreign Application Priority Data
Apr. 4, 2022 (DE) 10 2022 107 975.9

(51) Int. Cl. B62K 19/30; F16B 19/02; F16B 33/00; F16B 41/00

(52) U.S. Cl. CPC B62K 19/30; F16B 19/02; F16B 33/002; F16B 41/002

(57) ABSTRACT

In an embodiment, a module includes a module element having a hole and the hole having a first portion and a second portion. The module further includes a bushing inserted into the first portion of the hole and a pin inserted into the second portion of the hole, wherein the first portion and the second portion are arranged next to each other so that the inserted bushing and the inserted pin are also next to each other, wherein the inserted bushing and the inserted pin interact with each other, and wherein the module is configured such that, as a result of this interaction, the bushing is held in the hole and is secured against falling out of the hole.

### CROSS-REFERENCE TO RELATED APPLICATIONS

This patent application is a national phase filing under section 371 of PCT/EP2023/056284, filed Mar. 13, 2023, which claims the priority of German patent application 102022107975.9, filed Apr. 4, 2022, each of which is incorporated herein by reference in its entirety.

### TECHNICAL FIELD

A module for a bicycle, a kit for a bicycle and a bicycle are specified. In addition, a method for assembling a module and a method for mounting a module are specified.

### BACKGROUND

Bicycles are a cost-effective, easy-to-use and emission-free means of transportation. They have also become popular as sports and fitness equipment, and types of bicycles that are particularly suitable for different types of sports have emerged.

In recent years, there has been a growing enthusiasm for electric bicycles (especially so-called “pedelecs”), despite the high weight and price of bicycles. With electric bicycles, it is important to provide a reliable drive system that enables high power transmission. Such a drive system includes, for example, a module that must be mounted on a carrier, for example on the frame of the bicycle.

### SUMMARY

Embodiments provide an improved module for a bicycle, in particular a module that can be easily assembled and/or a module with integrated transport protection for individual components and/or a module that can be easily mounted. Further embodiments provide a kit for such a module and a bicycle with such a module. Yet additional embodiments provide methods for assembling such a module and for mounting such a module.

First, the module for a bicycle is specified.

In at least one embodiment, the module for a bicycle comprises a module element in which a hole is formed, the hole having a first portion and a second portion. Furthermore, the module comprises a bushing and a pin, the bushing being inserted into the first portion of the hole and the pin being inserted into the second portion of the hole. The first portion and the second portion are arranged next to each other so that the inserted bushing and the inserted pin also lie next to each other. The inserted bushing and the inserted pin interact with each other, wherein the module is configured in such a way that, as a result of this interaction, the bushing is held in the hole and is secured against falling out of the hole.

Embodiments of the present invention are based, inter alia, on the realization that bushings are usually pressed directly into the holes of a module element, for example with transition fit or press fit. Manual assembly is usually not possible, instead presses must be used. Expensive fitting systems must be made for this. With transition fit, the bushing can be lost during transport. If the bushing is too tight, this can lead to an unwanted load on the module element and/or on a carrier on which the module is mounted.

The bushing is held in the hole by means of a pin arranged next to the bushing. The bushing and the pin can be inserted into the hole of the module element without the use of tools, for example.

The module is, for example, part of a drive system, in particular an electric drive system, for a bicycle. The bicycle can, in particular, be a pedelec.

The module further comprises, for example, an electric motor and/or a gearbox with one or more gear wheels. For example, the module is configured for coupling to a pedal crank shaft of the bicycle. The module can have a receiving area for a pedal crank shaft, for example a further hole for the passage of the pedal crank shaft.

The module element is, for example, a housing element or housing of the module. For example, the module element is made of plastic or metal, such as aluminum. The module element can be formed in one piece.

The bushing and/or the pin are made of metal, for example. The bushing, also referred to as “sleeve”, is a hollow cylinder. The bushing may have a thread on the inside wall of the hollow cylinder to allow a screw to be screwed into the bushing to mount the module.

The hole is a continuous hole. This means that the two portions are not separated by solid material, but merge into one another. The hole can be one or more drillings in the module element. For example, the first portion is formed by a drilling and the second portion next to it is formed by a second drilling. The hole can extend completely through the module element, i.e. it can form a breakthrough through the module element. The hole then has two openings opposite to each other. Alternatively, the hole can be a blind hole with only one opening and a bottom opposite the opening, which is formed, for example, by the module element.

The two portions are adjacent to each other. This means that, when looking onto the opening of the hole from above, the two portions are arranged next to each other. Consequently, the inserted bushing and the inserted pin are also arranged next to each other when looking onto the opening of the hole from above. For example, the center axes of the inserted bushing and the inserted pin are offset from each other. The center axes can run parallel to each other.

The interaction between the inserted bushing and the inserted pin can be a mechanical and/or electromagnetic interaction. The pin therefore transfers a force to the bushing, which causes the bushing to be held in the hole. The force transferred to the bushing by the pin can point towards or away from the pin. The force exerted on the bushing can cause it to jam or tilt in the hole so that the bushing is held in the hole by a form fit. Alternatively, the force exerted on the bushing can hold the bushing in the hole solely by force closure, i.e. friction.

The bushing is secured against falling out of the hole due to the interaction. This means that the interaction with the pin is mainly or exclusively responsible for holding the bushing in the hole and preventing it from falling out. The fact that the bushing is prevented from falling out means that the gravitational force m_{B}·g, where m_{B} is the mass of the bushing and g is the gravitational constant, is not sufficient to pull the bushing out of the hole. In other words, a holding force that keeps the bushing in the hole is greater than m_{B}·g, for example greater than 5·m_{B}·g.

For example, the module is configured such that, without the pin inserted in the second portion, the bushing would fall out of the hole, i.e. when the gravitational force m_{B}·g acts on the bushing. Without the pin, a holding force that holds the bushing in the hole is therefore smaller than m_{B}·g.

The interaction that causes the bushing to be held in the hole and secured against falling out can also be mainly or exclusively responsible for the pin being held in the hole and secured against falling out. What has just been said for the bushing therefore also applies to the pin. The pin and the bushing therefore hold each other in the hole and secure each other against falling out.

Instead of a single hole with a first and a second portion, as described here, the module element can also have two separate holes arranged next to each other. The holes are separated from each other, for example, by a wall of the module element. The first portion, in which the bushing is inserted, is then formed by a first of these holes and the second portion, in which the pin is inserted, is then formed by a second of these holes. In this case too, the pin and the bushing can interact with each other, for example magnetically through the wall, to hold the bushing in the first hole and prevent it from falling out. It is also possible that, if the wall between the two holes is flexible, the bushing is held in the first hole and prevented from falling out by a purely mechanical interaction between the pin and the bushing. All features disclosed herein and in the following for the embodiment with a single hole with two portions apply accordingly to the embodiment with two separate holes for the bushing and the pin.

According to at least one embodiment, the module is arranged such that the bushing is axially displaceable relative to the module element and/or the pin, parallel to a center axis of the bushing. This means that the bushing, which is held in the hole by interaction with the pin, can be axially displaced without damaging or destroying any components of the module. In particular, the center axis of the bushing is an axis along which a screw can be screwed into the bushing, i.e. in particular the cylinder axis belonging to the bushing.

For example, the bushing is held in the hole and secured against falling out solely by frictional force, i.e. solely by force closure. By overcoming the holding force, i.e. the static friction force, the bushing can be displaced in the axial direction relative to the module element, and can even be pulled completely out of the hole.

According to at least one embodiment, the module is configured such that rotation of the bushing about its center axis relative to the module element and/or relative to the pin is blocked. For example, the bushing can be rotated relative to the module element and/or the bushing by at most a small angle, for example by at most ±5°. Any forced rotation beyond this, for example, will result in the destruction or damage of a component of the module. In particular, the rotation of the bushing can be blocked by a form fit with another component of the module, for example the pin or the module element.

The axially displaceable but non-rotatable bushing is secured against falling out during transportation. When the module is mounted, for example on a bicycle part, a screw is, for example, screwed into the bushing. The blocking of the rotation of the bushing ensures that the screw engages. At the same time, the axial displaceability of the bushing ensures that excessive axial loads on the module or the bicycle part are avoided when the screw is tightened.

According to at least one embodiment, the pin presses the bushing against an inner wall that delimits the first portion of the hole. This holds the bushing in the hole. The static friction force between the bushing and the inner wall caused by the pressure is, for example, large enough to prevent the bushing from falling out. The inner wall of the hole in the first portion is, for example, formed by the module element. The pin can press directly against the bushing, i.e. rest against the bushing. The bushing can be pressed directly against the inner wall, i.e. rest against the inner wall.

The force transmitted from the pin to the bushing particularly acts in a radial direction, for example exclusively in a radial direction, with respect to the center axis of the bushing. For example, a contact point or a contact line, in which the pin abuts against the bushing, lies on a connecting straight line or connecting plane between the center axes of the bushing and the pin.

According to at least one embodiment, the pin is a tension pin. The tension pin is, for example, radially pre-tensioned with respect to its center axis so that the tension pin presses radially outwards against the bushing.

The tension pin is in particular a slotted pin. For example, the tension pin is a hollow cylinder with a slot in the surface. The slot extends parallel to the cylinder axis/center axis of the pin.

Alternatively, the pin could also comprise or consist of a material compressed in the radial direction and be radially pre-tensioned by the compression. In this case, the pin would also press outwards.

According to at least one embodiment, the pin and the bushing engage with each other, i.e. they are in form-fit engagement. This engagement blocks, for example, the bushing from rotating about its center axis relative to the module element and/or pin.

According to at least one embodiment, the bushing has a notch in which the pin engages. Alternatively, the pin could also have a notch in which the bushing engages. In the area of the notch, the pin and the bushing are in direct contact with each other, for example.

The notch is, for example, elongated and extends in the axial direction, i.e. parallel to the center axis of the bushing or pin. The notch may be a groove. By engaging in an elongated notch extending in the axial direction, a relative axial movement between the pin and the bushing can be ensured and, at the same time, relative rotation can be blocked.

According to at least one embodiment, the pin is cylindrical. For example, the pin is hollow cylindrical.

According to at least one embodiment, the notch is formed in the lateral surface of the bushing.

According to at least one embodiment, the notch has the shape of a cylinder segment. In other words, a surface of the bushing (or of the pin, if the notch is formed in the pin) that delimits the notch is the lateral surface of a cylinder segment. The cylinder segment is, for example, less than a half cylinder. For example, the surface that delimits the notch extends around the associated respective cylinder axis of the cylinder segment by at most 150° and/or by at least 70°.

According to at least one embodiment, the shape of the notch is adapted to the shape of the pin so that the pin engages in the notch in a form-fitting manner. For example, the cylinder radius of the cylinder segment associated with the notch is adapted to the cylinder radius of the pin. For example, the cylinder radius of the cylinder segment is greater than the cylinder radius of the pin. The cylinder segment and the cylindrical pin can be coaxial with each other.

According to at least one embodiment, the first and second portion of the hole are each bounded by an inner wall having the shape of a lateral surface of a cylinder segment. The inner wall is formed, for example, by the module element in each case. In the following, the cylinder segment whose lateral surface corresponds to the shape of the inner wall in the area of the first portion is referred to as the cylinder segment of the first portion. Similarly, the cylinder segment whose lateral surface corresponds to the shape of the inner wall in the area of the second portion is referred to as the cylinder segment of the second portion.

According to at least one embodiment, the cylinder segments of the first and second portions are each larger than a half cylinder. This means that the inner wall of the respective portion extends around the respective cylinder axis by more than 180°, for example by at least 210° and/or by at most 320°.

According to at least one embodiment, the distance between the cylinder axes of the cylinder segments of the first and second portion is smaller than the sum of the cylinder radii of both cylinder segments and larger than each individual cylinder radius of the two cylinder segments.

The hole can therefore have the shape of two overlapping cylinders with parallel cylinder axes. In a plan view of the opening to the hole, the opening is bounded by a contour that then has the shape of two overlapping circles, in particular the shape of a figure eight.

The center axes of the bushing and the pin can be parallel to the cylinder axes of the first and second portions. Due to the interaction between the pin and the bushing, the center axis of the bushing is offset from the cylinder axis of the first portion, for example. Alternatively or additionally, the center axis of the pin can also be offset from the cylinder axis of the second portion.

According to at least one embodiment, the cylinder radius of the cylinder segment of the first portion is greater than the cylinder radius of the cylinder segment of the second portion. For example, the cylinder radius of the first portion is at least 1.2 times or at least 1.5 times as large as that of the second portion.

In the above-mentioned case of two separate holes, one for the bushing and one for the pin, the two holes are, for example, each cylindrical, that is, each in the form of a full cylinder. The same applies to the relative sizes of the cylinder radii of these full cylinders as to the relative sizes of the cylinder radii of the cylinder segments.

According to at least one embodiment, the radius of the bushing is greater than the radius of the pin. For example, the radius of the bushing is at least 1.2 times or at least 1.5 times the radius of the pin.

According to at least one embodiment, the module element is a housing for a drive system of the bicycle. The module is, for example, part of the drive system. For example, the module includes a drive device for the drive system. The module may include an electric motor and/or a gearbox of the drive system. The electric motor and/or the gearbox are, for example, surrounded by the housing or arranged inside the housing.

According to at least one embodiment, the bushing and the first portion of the hole are formed with a clearance fit relative to each other. In particular, the inner wall defining the first portion of the hole and the inserted bushing are spaced apart from each other in certain areas. For example, the cylinder radius of the cylinder segment of the first portion is larger, for example at least 1 mm or at least 2 mm larger, than the radius of the bushing.

According to at least one embodiment, the pin and the second portion of the hole are formed with a clearance fit relative to one another. In particular, the inner wall defining the second portion of the hole and the inserted pin are spaced apart from one another in certain areas. For example, the cylinder radius of the cylinder segment of the second portion is larger, for example at least 1 mm or at least 2 mm larger, than the radius of the pin.

The module may comprise several pairs, each with a bushing and a pin. Each pair is then assigned its own hole in the module element with a first and second portion or its own pair of holes with a first and second hole. All features disclosed in connection with the one pair of bushing and pin described here are also disclosed for all other pairs of bushing and pin.

Next, the bicycle kit is disclosed. In particular, the kit can be assembled into a module as described herein. Therefore, all features disclosed in connection with the module are also disclosed for the kit and vice versa.

In at least one embodiment, the kit comprises a module element having a hole, the hole having a first and a second portion. Further, the kit comprises a bushing and a pin. The hole, the bushing and the pin are adapted to each other such that the bushing is insertable into the first portion of the hole, the pin is insertable into the second portion of the hole, and the inserted pin and bushing then interact with each other such that the bushing is held in the hole and secured against falling out of the hole.

The kit differs from the module in that the pin and/or the bushing are not yet inserted into the hole. The pin and bushing can therefore be handled separately from each other and separately from the module element.

The next step is to describe the method for assembling a module. In particular, the method can be used to assemble a module according to one of the embodiments described here. All features disclosed in connection with the module are therefore also disclosed for the method and vice versa.

In at least one embodiment of the method of assembling a module, the method comprises a step of providing a kit. The kit is a kit described herein comprising a module element, a bushing and a pin. In one step, the bushing is inserted into the first portion of the hole of the module element. In a further step, the pin is inserted into the second portion of the hole. The inserted bushing and pin interact with each other and, as a result of this interaction, the bushing is held in the hole and subsequent falling out of the bushing from the hole is prevented.

For example, the pin is inserted first, followed by the bushing. When the bushing is inserted, the already inserted pin can be radially pre-tensioned and, as a result, press radially outwards against the bushing, thereby pressing the bushing against an inner wall of the hole.

Alternatively, the bushing is inserted first and then the pin. For example, when the pin is inserted, the pin is radially pre-stressed due to the interaction with the bushing and consequently presses radially outwards against the bushing, so that the bushing is pressed against the inner wall of the hole.

The bushing and/or the pin are inserted into the first and second portions, respectively. This means that rotation about their respective center axes is not required during insertion.

The method for assembling a module is then given.

In at least one embodiment of the method of mounting a module, a module according to one of the embodiments described herein is used and a connecting element is inserted into a bicycle part for a bicycle and into the bushing to connect the module to the bicycle part.

For example, the bicycle part has a hole into which the connecting element is inserted or through which the connecting element is inserted. The hole may be a hole through the bicycle part. For example, the connecting element is first inserted through the hole in the bicycle part and then into the bushing.

According to at least one embodiment, the connecting element is a screw. The bushing then has an internal thread that is brought into engagement with the external thread of the screw when the screw is inserted.

In at least one embodiment, the bushing is axially displaced relative to the module element when the screw is screwed into the bushing. For example, when the screw is screwed in, the bushing moves towards the bicycle part. The axial displaceability of the bushing can be used to avoid tension in the module element and/or the bicycle part. The rotational blocking of the bushing also ensures that the bushing does not rotate when the screw is screwed in, thus allowing the screw to be screwed into the bushing.

The bicycle part can be a frame or frame section of the bicycle, for example a down tube or seat tube of the frame. For example, the module is mounted in the frame, i.e. inside the tube.

Next, the bicycle is indicated. For the assembly of the bicycle, the module is mounted on a bicycle part of the bicycle, whereby the above-indicated method can be used. All features disclosed in connection with the method for mounting a module are therefore also disclosed for the bicycle and vice versa.

In at least one embodiment, the bicycle comprises a module described herein and a frame. The module is connected to the frame by a screw threaded into the bushing. For example, the module is located in the frame. For example, the module is screwed to or in the seat tube or down tube of the bicycle. A wall of the frame is then positioned, for example, between the screw head and the bushing.

The bicycle is, for example, an electric bicycle, in particular a pedelec.

### BRIEF DESCRIPTION OF THE DRAWINGS

A module, a kit, a bicycle and a method for assembling or mounting a module described herein are explained in more detail below with reference to drawings based on examples of designs. Identical reference signs indicate identical elements in the individual figures. Insofar as elements or components in the various figures have the same function, their description will not be repeated for each of the following figures. For reasons of clarity, elements may not be provided with corresponding reference signs in all illustrations.

FIG. 1 shows an example of an electric bicycle;

FIG. 2 shows a design example of the module in a top view;

FIGS. 3 and 4 show detailed views of the design example in FIG. 2;

FIG. 5 shows a design example of the kit in a perspective view during assembly into a module;

FIG. 6 shows a further position during the assembly of a module;

FIG. 7 shows a position in an example of the method for assembling a module; and

FIG. 8 shows an example of the fully assembled module.

### DETAILED DESCRIPTION OF ILLUSTRATIVE EMBODIMENTS

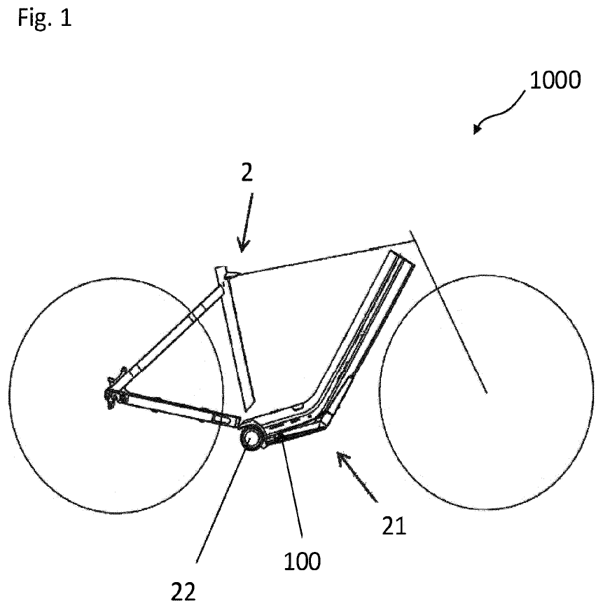

FIG. 1 shows a schematic of an electric bicycle 100 with a bicycle frame 2, which, among other things, has a lower frame section 21 that forms a down tube.

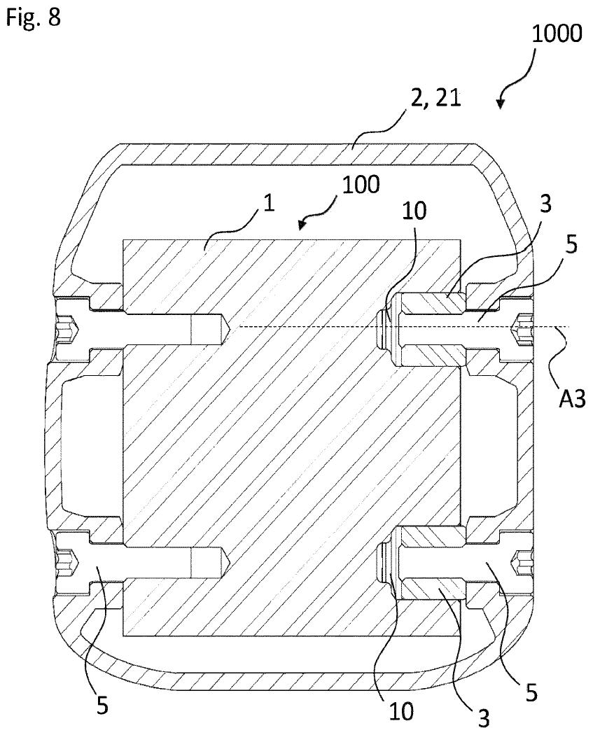

The frame section 21 extends in the direction of a bottom bracket that includes a bottom bracket spindle 22 that is or can be coupled to a drive mechanism for the electric bicycle. The drive mechanism comprises, for example, a gearbox and/or an electric motor. The drive mechanism is here part of a separately provided module 100 which is installed in the frame 2, for example screwed inside the down tube 21 (see also FIG. 8).

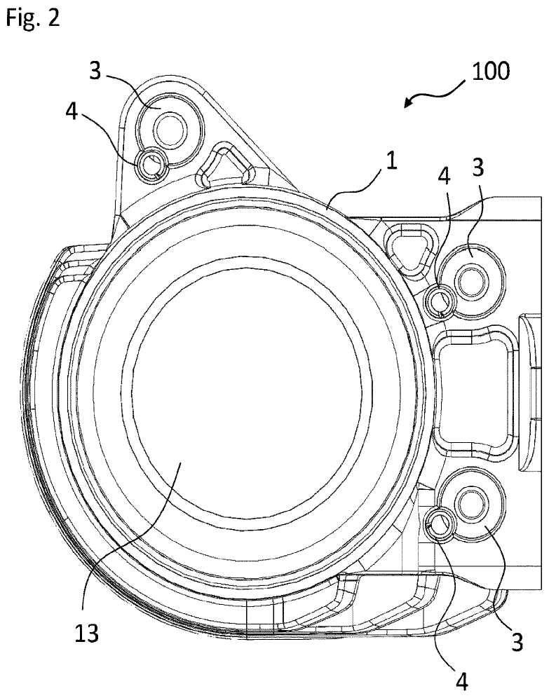

FIG. 2 shows an example of the module 100 in a top view. This may be the module 100 of FIG. 1. The module 100 comprises a module element 1 in the form of a housing 1. The housing 1 is made of metal, for example, such as aluminum. The gearbox and/or electric motor are located inside the housing 1. The housing 1 includes a receptacle 13 for a pedal crank shaft 22. The pedal crank shaft 22 can be inserted through the receptacle 13, for example.

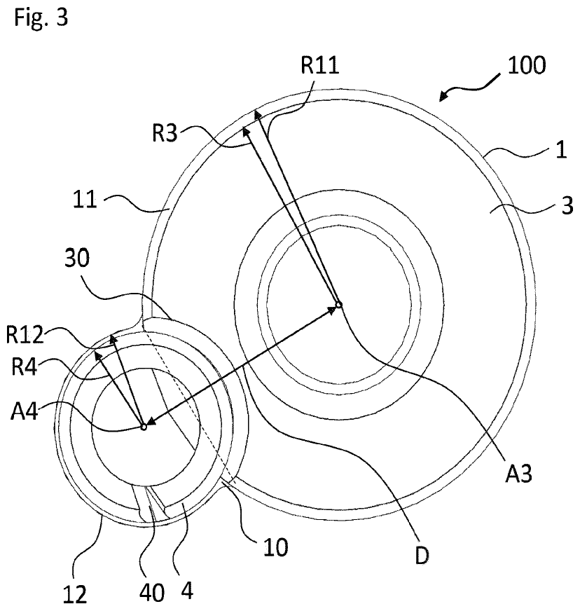

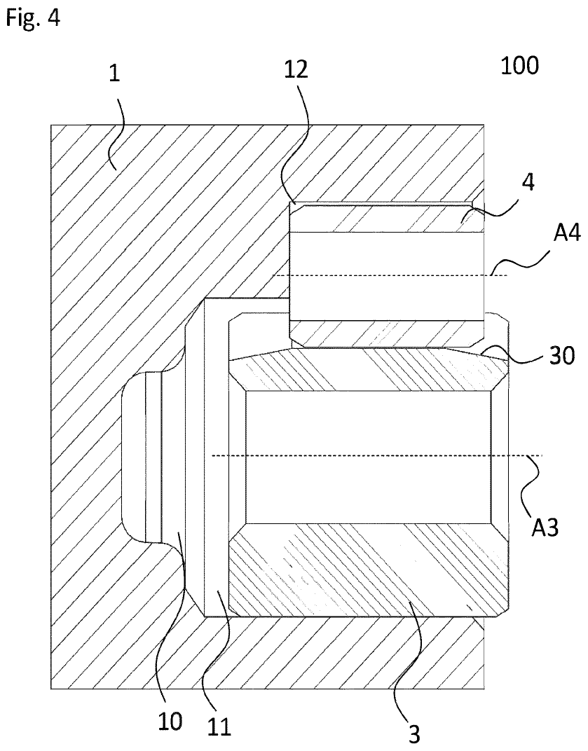

A bushing 3 and a pin 4 are inserted into the housing 1 at various points. This is shown in more detail in FIG. 3 in a detailed top view and in FIG. 4 in a detailed sectional view. The sectional view in FIG. 4 is a section through the center axes A3, A4 of the bushing 3 and the pin 4.

FIG. 3 shows that a hole is formed in the housing 1, which comprises a first portion 11 and a second portion 12. Both the first 11 and the second 12 sections each have the shape of a cylinder segment or, in the top view shown, the shape of a circle segment. The virtual boundary between the first portion 11 and the second portion 12 is shown as a dashed line.

The hole 10 with the two cylindrical segments 11, 12 can be produced, for example, by drilling. To do this, a first hole is drilled and then a second hole is drilled overlapping the first hole.

The bushing 3 is inserted into the first portion 11 of the hole 10. The cylindrical pin 4 is inserted into the second portion 12. The bushing 3 and the associated section 11 are on a clearance fit. This means that the radius R3 of the bushing 3 is smaller than the radius R11 of the cylinder segment associated with the first portion 11. Likewise, the pin 4 and the second portion 12 are on a clearance fit and, accordingly, the radius R4 of the pin 4 is smaller than the radius R12 of the cylinder segment assigned to the second portion 12.

As can be seen, the distance D between the essentially parallel center axes A3, A4 of the bushing 3 and the pin 4, or the distance D between the cylinder axes of the cylinder segments, is smaller than the sum of the radii R3 and R4 or the sum of the radii R11 and R12, but greater than each of the radii R3 and R4 or each of the radii R11 and R12. This is achieved, among other things, by providing a notch 30 in the surface of the bushing 3, which also has the shape of a cylinder segment or, in the top view shown, of a circle segment. While the cylinder segments that give sections 11 and 12 their shape are each larger than a half cylinder, the cylinder segment that gives the notch 30 its shape is smaller than a half cylinder. The notch 30 is adapted to the shape of the pin 4 so that the pin 4 engages positively in the notch 30. The cylinder axis of the cylinder segment of the notch is, for example, coaxial with the center axis A4. The interlocking of pin 4 and bushing 3 blocks rotation of the bushing 3 about its center axis A3 relative to the pin 4 and relative to the housing 1.

In this case, the pin 4 is a tension pin in the form of a hollow cylinder with a slot 40. The slot 40 extends predominantly axially, in a direction parallel to the center axis A4 of the pin 4. The tension pin 4 is radially pre-tensioned so that it presses radially outwards on the bushing 3 in the area of the notch 30, thus pushing the bushing away from itself. The bushing 3 is thereby pressed against the inner wall of the housing 1, which bounds the hole 10, on the side diagonally opposite the tension pin 4. The forces with which the pin 4 is pressed against the bushing 3 and the bushing 3 against the housing 1 result in a static friction force for an axial movement of the bushing 3 parallel to the center axis A3, which is so great that the bushing 3 is prevented from falling out of the hole 10. The pin 4 also presses against an inner wall of the housing 1 that delimits the second portion 12 of the hole 10. The resulting static friction force for an axial movement parallel to the center axis A4 can also be sufficient to keep the pin 4 in the hole 10 and prevent it from falling out.

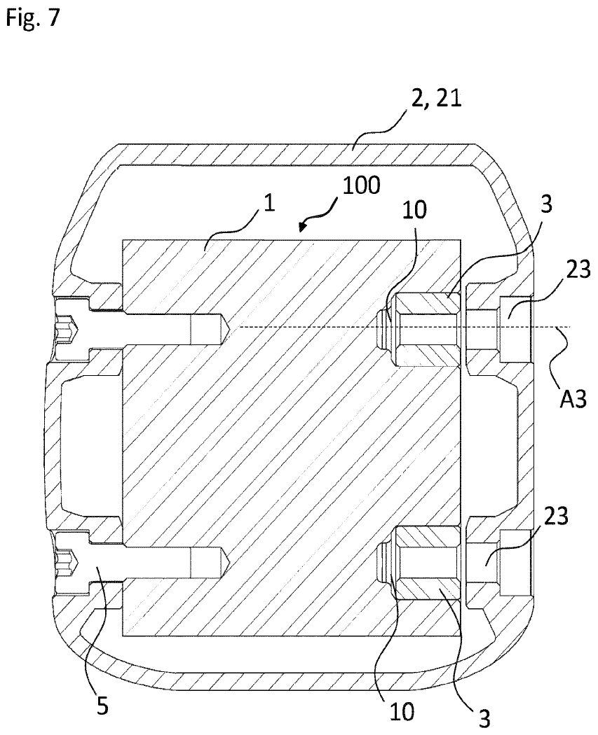

In the example shown, the bushing 3 and/or the pin 4 are held in the hole 10 only by frictional contact, i.e. solely by frictional force. Consequently, by overcoming the static friction force, the bushing 3 and/or the pin 4 can be displaced axially, i.e. in a direction parallel to the respective center axis A3, A4. This is an advantage when assembling module 100 (see also description of FIGS. 7 and 8).

It should be noted that the use of a tension pin 4 to hold the bushing 3 in the hole 10 is only an example. For example, the bushing 3 could also be designed as a tension pin and radially pre-tensioned so that it presses radially outwards against the pin 4. Alternatively, it is also conceivable that the bushing 3 and the pin 4 are magnetic and, for example, repel each other, thus being pressed against the inner walls of the hole 10. Ultimately, various types of interaction between the pin 4 and the bushing 3 can result in the bushing 3 and/or the pin 4 being held in the hole 10 and secured against falling out.

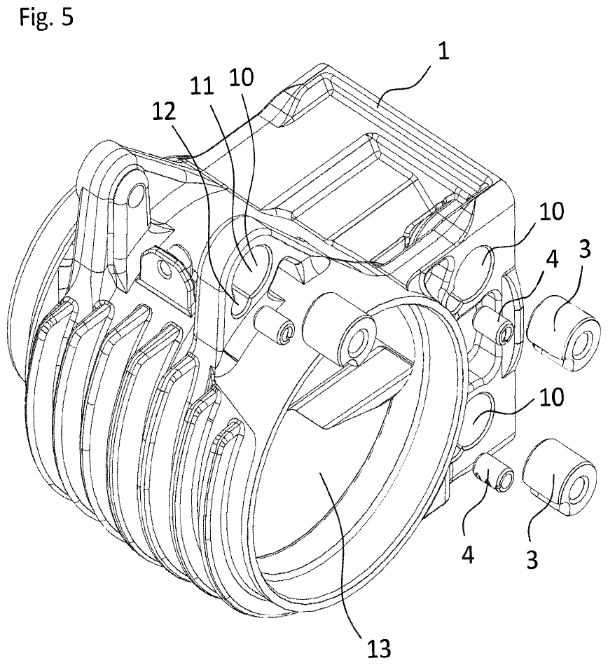

FIG. 5 shows an example of how the kit can be assembled. The kit comprises a module element 1 in the form of a housing 1, several bushings 3 and several tension pins 4. The bushings 3 and the tension pins 4 have not yet been inserted into the holes 10 provided for them, each with two portions 11, 12. The kit shown in FIG. 5 can be assembled to form the module 100 shown in the previous figures.

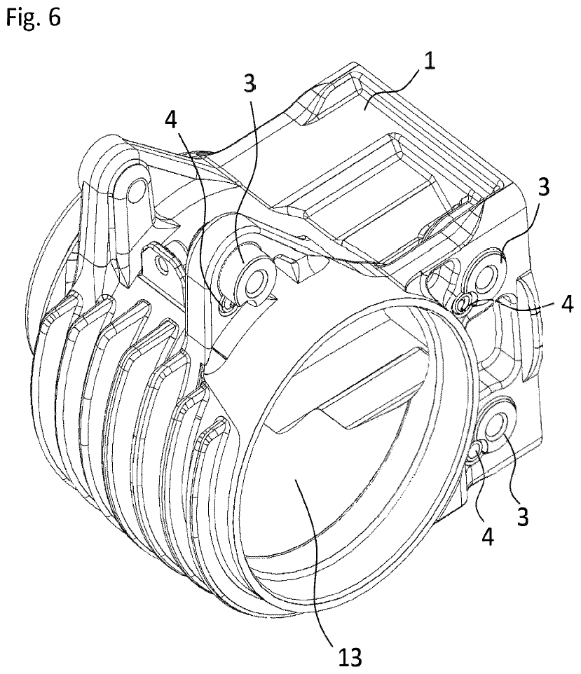

FIG. 6 shows a position during the assembly of the module 100. In two of the three holes 10, a bushing 3 and a tension pin 4 have already been inserted. In a third hole 10, a tension pin 4 is inserted into the second portion 12 of the hole. FIG. 6 shows the position while the bushing 3 is inserted into the third hole 10 or its first portion 11. When the bushing 3 is inserted, the tension pin 4 is radially compressed by the bushing 3, i.e. pre-tensioned, so that a force acts on the bushing 3 in a radially outward direction with respect to the center axis A4, pressing the bushing 3 against the inner wall of the hole 10.

FIG. 7 shows a cross-section during the assembly of the module 100 on a bicycle part 2, in this case the frame 2 of the bicycle. To be more precise, the module 100 is mounted inside the tubular lower frame section 21 of the frame 2. In FIG. 7, Module 100 is already pre-assembled, with screws 5 that are inserted from the outside through the wall of Frame 2, 21 and screwed into Module 100 (see left side of FIG. 7). The right side of Module 100 is designed to accommodate the bushes 3, which are held in place by means of the tension pins 4. The bushes 3 are sleeves with an internal thread. Through holes 23 in frame 2, connecting elements 5 in the form of screws 5 can then be screwed through the holes 23 into the bushes 3 to finally mount or fix the module 100 to the frame.

This is shown in FIG. 8, which shows a position after the screws 5 have been fully screwed into the bushes 3. Since the bushes 3 are secured against rotation, they do not rotate when the screws 5 are screwed in. When the screw 5 is tightened, as can be seen by comparing FIGS. 7 and 8, the bushes 3 are pulled out axially along their respective center axes A3 from the hole 10 in the housing 1 and then hit, for example, the frame 2. This axial displaceability of the bushes 3 relieves the frame 2 and the housing 1 axially when the screws 5 are tightened. Without this displaceability, the frame 2 or the housing 1 would be subjected to (increased) axial tension when the screws are tightened.

The invention is not limited to the description based on the examples of implementation. Rather, the invention includes every new feature and every combination of features, which in particular includes every combination of features in the patent claims, even if these features or this combination itself is not explicitly stated in the patent claims or examples of implementation.

1-15. (canceled)

16. A module comprising:
a module element comprising a hole, the hole having a first portion and a second portion;
a bushing inserted into the first portion of the hole; and
a pin inserted into the second portion of the hole,
wherein the first portion and the second portion are arranged next to each other so that the inserted bushing and the inserted pin are also next to each other,
wherein the inserted bushing and the inserted pin interact with each other, and
wherein the module is configured such that, as a result of this interaction, the bushing is held in the hole and is secured against falling out of the hole.

17. The module according to claim 16,
wherein the bushing is displaceable in axial direction, parallel to a center axis of the bushing, relative to the module element, and
wherein a rotation of the bushing about its center axis and relative to the module element is blocked.

18. The module according to claim 16, wherein the pin presses the bushing against an inner wall delimiting the first portion of the hole, and wherein the bushing is held in the hole.

19. The module according to claim 16, wherein the pin is a tension pin, which is radially pre-tensioned with respect to its center axis so that it presses radially outwards against the bushing.

20. The module according to claim 16, wherein the bushing and the pin engage with each other, and wherein a rotation of the bushing about its center axis is blocked.

21. The module according to claim 20, wherein the bushing has a notch in which the pin engages.

22. The module according to claim 21,
wherein the pin is cylindrical,
wherein the notch is formed in the lateral surface of the bushing,
wherein the notch is in form of a cylinder segment, and
wherein a shape of the notch is adapted to the shape of the pin so that the pin engages in the notch in a form-fitting manner.

23. The module according to claim 16,
wherein each of the first portion and the second portion is bounded by an inner wall having a shape of a lateral surface of a cylinder segment,
wherein each cylinder segment is larger than a half cylinder,
wherein a distance between cylinder axes of the cylinder segments is smaller than a sum of cylinder radii of both cylinder segments and larger than each individual cylinder radius of the two cylinder segments.

24. The module according to claim 16, wherein the module element is a housing for a drive system of the bicycle.

25. The module according to claim 16,
wherein the bushing and the first portion of the hole are formed with a clearance fit relative to each other, and
wherein the pin and the second portion of the hole are formed with a clearance fit relative to each other.

26. A method for mounting the module according to claim 16, the method comprising:
inserting a connecting element into a bicycle part for the bicycle and into the bushing to connect the module to the bicycle part.

27. The method according to claim 26,
wherein the connecting element is a screw,
wherein the bushing has an internal thread, which is engageable with the thread of the screw, and
wherein, when the screw is screwed into the bushing, the bushing is axially displaced relative to the module element.

28. A bicycle comprising:
the module according to claim 16; and
a frame,
wherein the module is connected to the frame via a screw screwed into the bushing.

29. A kit for a bicycle comprising:
a module element with a hole, the hole having a first and a second portion;
a bushing; and
a pin,
wherein the hole, the bushing and the pin are adapted to one another such that the bushing is insertable into the first portion of the hole, the pin is insertable into the second portion of the hole, and the inserted pin and the inserted bushing then are able to interact with one another such that the bushing is held in the hole and secured against falling out of the hole.

30. A method for assembling a module, the method comprising:
providing the kit according to claim 29;
inserting the bushing into the first portion of the hole of the module element; and
inserting the pin into the second portion of the hole of the module element,
wherein the inserted bushing and the inserted pin interact with each other and, due to the interaction, the bushing is held in the hole and a subsequent falling out of the bushing from the hole is prevented.
